(19) United States
(12) Patent Application Publication
(10) Pub. No.: US 2018/0074836 A1
(43) Pub. Date: Mar. 15, 2018

(54) INCREASING PRECISION OF A PROCESS MODEL WITH LOOPS

(71) Applicant: CA, Inc., New York, NY (US)

(72) Inventors: Marc Solé Simó, Barcelona (ES); David Sanchez Charles, Barcelona (ES); Victor Muntés-Mulero, Barcelona (ES); Jose Carmona, Barcelona (ES)

(21) Appl. No.: 15/260,449

(22) Filed: Sep. 9, 2016

(51) Int. Cl. G06F 9/455

(52) U.S. Cl. CPC G06F 9/455

(57) ABSTRACT

A process model can be modified to be more precise by unrolling loops of the process model and evaluating or using the process model with the loops unrolled. After determining loops in a process model, sequential forward path executions of each loop identified in an input process model are counted within each trace of an event log. For each loop, a greatest common divisor (gcd) of the sequential forward path execution counts is determined. An intermediate process model is then created with the loops unrolled according to the respective gcd(s). The event log is then (re)played with the intermediate process model to identify traversed elements of the process model. Elements of the intermediate process model that were not traversed are removed to yield a more precise process model.

### BACKGROUND

The disclosure generally relates to the field of data processing, and more particularly to modelling.

Any of a variety of systems that use and/or generate workflow data or process data (e.g., a workflow management system, an enterprise resource planning system, a customer relationship management system, and a supply chain management system) can use process mining. Literature from the Institute of Electrical and Electronics Engineers (IEEE) describes process mining as a bridge between 1) process modelling and analysis and 2) data mining and machine learning. Process mining can be used for three different purposes: model discovery or extraction, conformance analysis, or model extension. For model discovery, a process mining algorithm is used to construct a process model from event data. The process model may be represented in various forms, e.g., as a Petri net, pi calculus expression, process tree, business process model and notation (BPMN), event-driven process chain (EPC), or uniform modeling language (UML) activity diagram. For conformance analysis, a model is evaluated with an event log to determine alignment between the model and the event log by determining deviations and commonalities between the event log and the model. The results of conformance analysis can be used to modify fit of the model. For model extension, a process model can be enriched by adding information beyond activities and transitions. Examples of the additional information include performance data and resource information.

Quality of a process model can be described in terms of fitness, simplicity, precision, and generalization. Fitness of a process model refers to how closely the process model aligns with an event log. If all traces in an event log can be replayed by a process model, then that model has perfect fitness. Perfect fitness, however, is generally not the goal because the process model should be able to generalize and capture behaviour beyond that expressed in the event log and not be limited to only reproducing the event log. If a process model captures most behavior expressed in the event log while also generalizing beyond the event log, then the process model is considered to be a good fit for the event log with some generalization. The “precision” of a process model quantifies the fraction of behavior allowed by a process model beyond the event log. Finally, a simple process model may be sought for reasons relating to efficient implementation and/or use of the process model. However, a simple model may be underfitting, which would be a process model that generalizes “too much.”

The aforementioned event log is the basis for processing mining. A system sequentially records events into an event log. An event relates to an activity, which is a well-defined step in a process. The process mining literature refers to an instance of a process as a “case.” For example, a first case of a process may be an entity making a purchase in a purchasing system and a second case of the process may be for a different entity making a purchase for a same of different item(s) in the purchasing system. Event logs are not limited to recording events and can also record information about the events, e.g., the resource (i.e., person or device) executing or initiating the activity related to an event, the timestamp of the event, or data elements recorded with the event (e.g., a credit rating).

### BRIEF DESCRIPTION OF THE DRAWINGS

Embodiments of the disclosure may be better understood by referencing the accompanying drawings.

FIGS. 1-2 depict a conceptual diagram of an example process model refiner unrolling determined loops in a process model and removing non-traversed elements to yield a more precise process model.

FIGS. 3-4 depict an example of unrolling loops based on greatest common divisor of loop counts across traces to yield a more precise process model expressed as a process tree.

FIG. 5 is a flowchart of example operations for process model precision modification.

FIGS. 6-11 depict an example refinement from loop unrolling for a process model that has a nested loop and concurrency.

FIGS. 12 -14 depict flowcharts of example operations for loop unrolling based process model refinement that accounts for concurrency and nested loops.

FIG. 15 depicts an example computer system with a process model refiner.

### DESCRIPTION

The description that follows includes example systems, methods, techniques, and program flows that embody embodiments of the disclosure. However, it is understood that this disclosure may be practiced without these specific details. For instance, the example illustrations refer to a single event log. Embodiments, however, can use multiple event logs for creating a more precise process model. In other instances, well-known instruction instances, protocols, structures and techniques have not been shown in detail in order not to obfuscate the description.

Terminology

A process model at least describes control-flow of a process. Constructs of this control-flow description include sequence, parallel routing (AND-splits/joins), choice (XOR splits/joins), and loops. A process model is often presented for visual presentation as a diagram. When this description refers to a process model, the term is used to refer to a machine representation of a process model (e.g., the data structures and data that can be used to graphically depict a process model). Accordingly, control-flow description constructs of a process model are referred to as elements of a process model. For a machine representation of a process model, the process model elements are the data and/or data structures corresponding to the constructs. These may also be referred to as nodes and edges.

The description also refers to a trace, which is used in process mining literature. A trace refers to a recorded event sequence for a process instance that includes a complete event sequence from start to end. However, a “complete” event sequence does not necessarily mean that the process instance successfully completed. A complete event sequence may end with an error, for instance.

Overview

A process model can be modified to be more precise by unrolling/unfolding loops of the process model and evaluating or using the process model with the loops unrolled. After determining loops in a process model, a process model refiner counts sequential forward path executions of each loop identified in an input process model within each trace of an event log. For each loop, the process model refiner determines a greatest common divisor (gcd) of the sequential forward path execution counts, and then creates an intermediate process model with the loops unrolled according to the respective gcd(s). The process model refiner (re)plays the event log with the intermediate process model to identify traversed elements of the process model. The process model refiner then removes elements of the process model that were not traversed to yield a more precise process model.

Example Illustrations

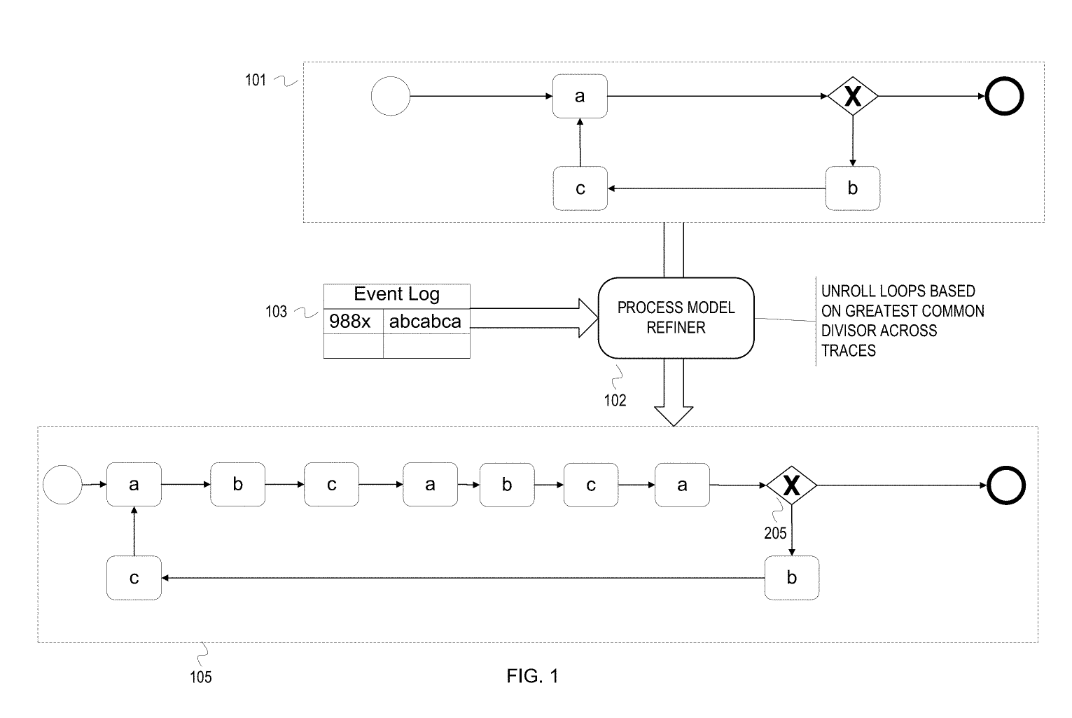

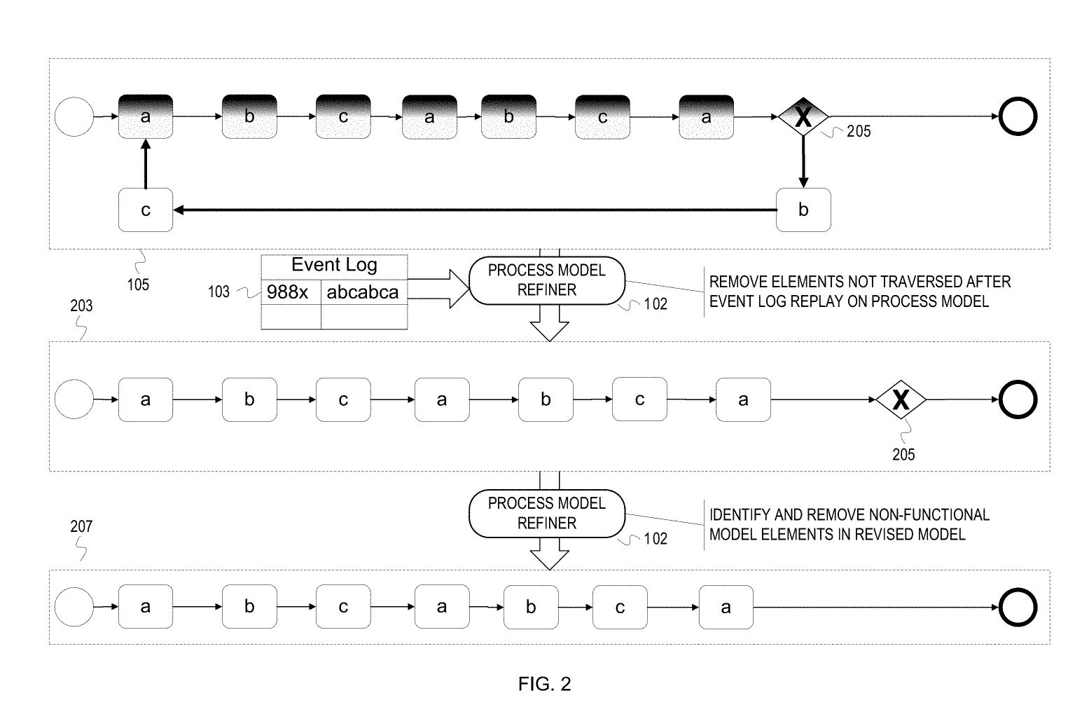

FIGS. 1-2 depict a conceptual diagram of an example process model refiner unrolling determined loops in a process model and removing non-traversed elements to yield a more precise process model. FIGS. 1-2 use a simple process model with a single loop for ease of explanation. FIG. 1 depicts the example process model refiner unrolling a loop based on a gcd of sequential execution counts of the determined loops. A process model refiner 102 determines a loop in a process model 101 that is based on an event log 103. FIG. 1 depicts a single trace in the event log 103 as “abcabca” executing 988 times. The process model refiner 102 identifies a forward path of the determined loop as the event “a” and the backward path as the event sequence “bc.” After determining the loop, the process model refiner 102 uses the event log 103 to count sequential occurrences/executions of the forward path. Based on the event log 103, the forward path executed 3 times. To “unroll” the loop and create a modified process model 105, the process model refiner 102 modifies the process model 101 by inserting 2 instance of the event sequent “abc” prior to execution of the event “a” prior to the choice element for exiting or repeating the loop. This results in the modified process model 105 having 3 instances of the forward path “a” The last instance of event “a” is followed by a gateway element 205 that chooses between looping back through the backward path of “bc” or exiting the process.

In FIG. 2, the process model refiner 102 has replayed the event log 103 on the modified process model 105 and marked elements traversed during the replaying of the event log 103. For illustrative purposes, FIG. 2 depicts the marking with gradient marking. Based on the replay, the backward path of “bc” after the gateway element 205 is not traversed. Since it is not traversed, the process model refiner 102 removes the non-traversed elements representing the backward path from the process model 105 to yield a modified process model 203. After removing the non-traversed elements, the process model refiner 102 identifies and removes non-functional model elements from the process model 203. In the process model 203, the exclusive gateway element 205 has a single incoming path and a single outgoing path. With a single incoming path and a single outgoing path, the exclusive gateway element 205 no longer provides a function. So, the process model refiner 102 removes the gateway element 205 from the process model 203 to yield a process model 207.

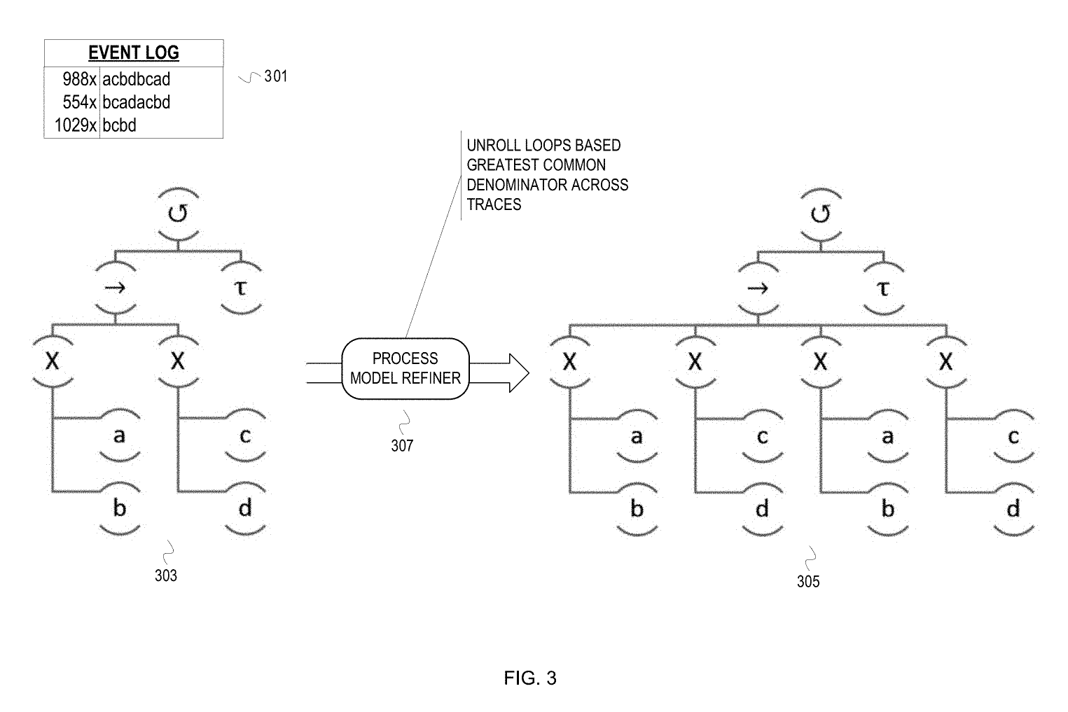

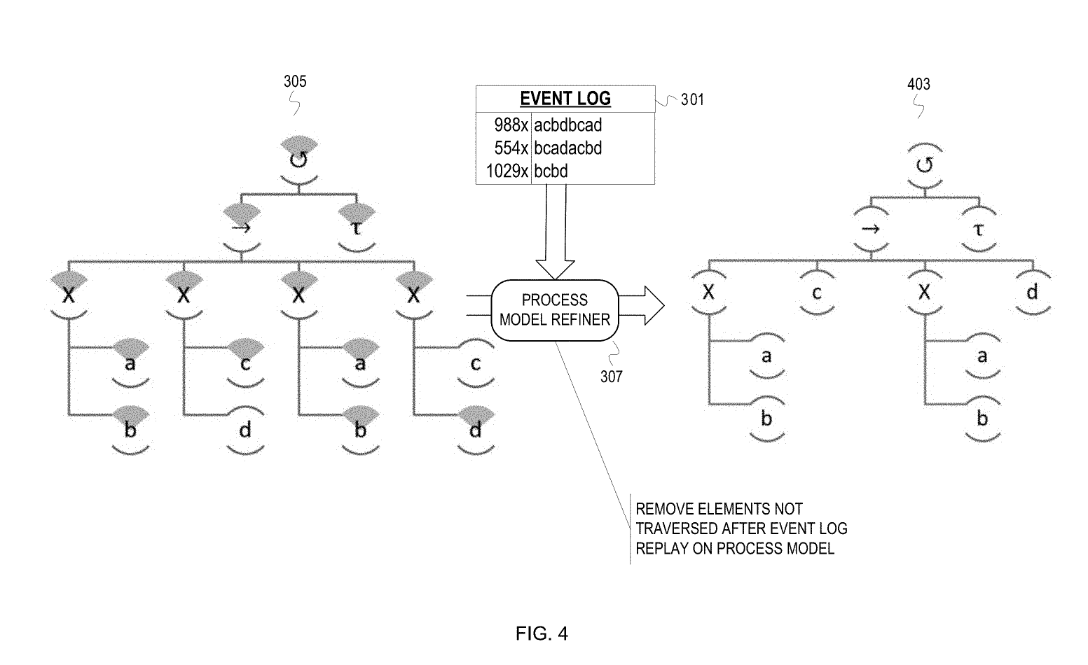

Although FIGS. 1-2 refer to a BPMN type of process model, embodiments are not limited to a specific type of process model. FIGS. 3-4 depict an example of unrolling loops based on gcd of loop counts across traces to yield a more precise process model expressed as a process tree. FIG. 3 depicts an example process model refiner unrolling loops determined in a process tree based on a gcd of loop counts. In FIG. 3, a process tree 303 is based on an event log 301. The event log 301 includes 3 traces. The first trace “acbdbcad” was executed 988 times. The second trace “bcadacbd” was executed 554 times. The third trace “bcbd” was executed 1029 times. A process model refiner 307 can determine loops based on the semantics of the process tree 303. The process tree 303 includes a root node that explicitly identifies a loop with a loop value. The left child node indicates a transition value and the right child node indicates a silent or invisible transition value. The forward path node has a left child node (“left XOR node”) and a right child node (“right XOR node”), each of which indicates exclusive OR (XOR) choices. The left XOR node indicates a choice between an event “a” and an event “b”. The right XOR node indicates a choice between an event “c” and an event “d”.

With the explicit indication of a loop, the process model refiner 307 can efficiently identify the loop and start counting sequential executions across traces in the event log 301. Based on the process tree 303, a loop will begin with either a orb and end with c or d. The process model refiner 307 counts 4 sequential executions of the loop beginning with a/b in the first trace and in the second trace. The process model refiner 307 counts 2 sequential executions of the loop beginning with a/b in the third trace. The gcd of these counts for the loop a/b is 2. So, the process model refiner 307 unrolls the loop twice to produce a modified process tree 305. The modified process tree 305 has a looping event sequence of a XOR b, c XOR d, a XOR b, c XOR d. This is expressed as a root loop node with the transition element and the silent transition element as before. However, the modified process tree 305 now has four XOR child nodes. The leftmost XOR child node indicates a choice between events a and b. The adjacent XOR child node indicates a choice between events c and d. The XOR child node adjacent to the rightmost XOR node indicates a choice between events a and b. The rightmost XOR child node indicates a choice between events c and d.

FIG. 4 depicts the process model refiner 307 replaying the event log 301 to identify non-traversed elements for removal. The process model refiner 307 executes each of the traces in the event log 301 and marks the elements traversed. FIG. 4 depicts the traversed elements with a marking at the top portion of each traversed element. The process model refiner 307 then removes those of the elements that lack a marking (i.e., those elements not traversed during replaying of the event log). During replaying of the event log 301, the event node d under the second XOR child node from the left of the process tree was not traversed, and the event node c under the rightmost XOR child node was not traversed. The process model refiner 307 removes these non-traversed elements. After removal of these event nodes, the second X node from the left of the process tree and the rightmost X node are now non-functional. The process model refiner 307 also removes these non-functional elements. Removal of the non-traversed elements and non-functional elements yields a more precise process tree 403.

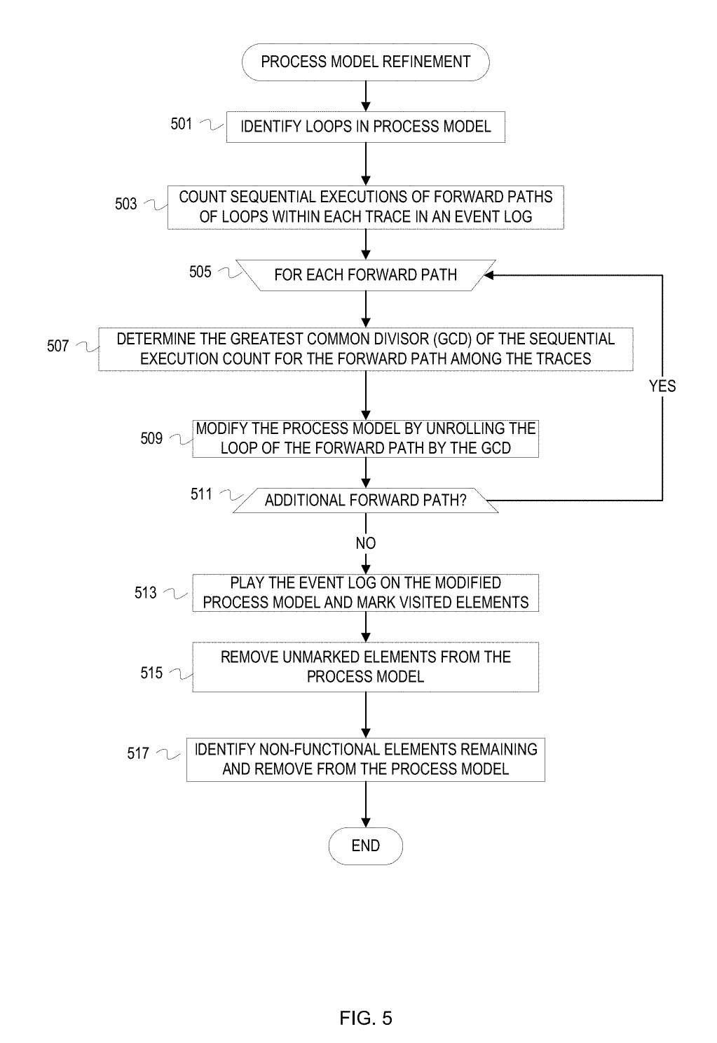

FIG. 5 is a flowchart of example operations for process model precision modification. FIG. 5 refers to a process model refiner as performing the operations. The process model being refined has been discovered from an event log with any of the available process mining techniques for model discovery. It should be understood that “process model refiner” is a moniker used for ease of explanation and does not identify any particular computer program, software library, etc. Naming and organization of program code to perform the described operations can vary by platform, developer/programmer preference, programming language, etc.

With a process model based on an event log, a process model refiner identifies loops within the process model (501). A process model may explicitly indicate a loop (e.g., in process trees). Identifying the loop may be recording a reference to the loop indicating node, marking the node, using an identifier of the node to identify the loop, etc. In some cases, the process model refiner analyzes a process model to discover loops before identifying loops. The process model refiner can use any of a variety of techniques for discovering loops depending upon the type of process model. For other types of process models, the process model refiner can use topological sort or depth first search (DFS), for example, to discover loops within the process model. Identification of a loop can involve determining the forward path of the loop, the backward path of the loop, and the exit point of the loop. The exit point of a loop will typically correspond to a choice or gateway type of element of the process model. Establishing identity of a loop can also vary by the type of process model. For instance, a loop in a BPMN type of process model can be identified by an event or event sequence that is the forward path of the loop.

After identifying the loops, the process model refiner uses the event log corresponding to the process model to count sequential loop executions (503). The process model refiner can count sequential executions by associating counters with elements corresponding to forward paths of loops and replaying the event log. The process model refiner associates a counter with each entry point element or forward path element of each loop. While replaying the event log on the process model, the process model refiner increments the counter for each loop execution until a loop exit occurs. When a loop exit is detected during the replaying of the event log, the process model refiner saves the counter value and resets the counter for any subsequent sequential executions of the loop. For example, the process model refiner pushes the counter value into a queue of sequential execution counts for the particular loop. That loop's queue of sequential execution counts can be evaluated to determine gcd after replaying of the event log completes. The process model refiner can also count sequential executions by examining patterns within each trace of the event log. The process model refiner, for example, could define a loop pattern and count sequential repeats of that pattern.

After determining the sequential executions of a forward path(s) within each trace of the event log, the process model refiner modifies the process model based on the execution counts for each loop (505). The process model refiner determines the gcd of the counts across traces for the forward path (507). With reference to FIG. 4, the event log 301 revealed execution counts of the forward path (a XOR b) 4 times in the first two traces of the event log 301 and an execution count of the forward path (a XOR b) 2 times in the third trace. The gcd of (4,4,2) is 2. The process model refiner uses the gcd to modify the process model by unrolling the loop corresponding to the forward path (509). In the case of a gcd of 2, the process model refiner unrolls the loop twice. After unrolling the loop, the process model refiner moves on to the next determined loop if one remains (511).

The resulting modified process model can be considered an intermediate process model since it is between the input process model and the final process model. With the intermediate process model, the process model refiner replays the event log on the modified process model and marks visited/traversed elements of the modified process model (513). The process model refiner can track visited elements separately from the process model or update a field or flag in each visited element of the process model if the process model elements include a field or flag for indicating traversal of the element.

The process model refiner removes elements from the modified or intermediate process model that were not visited during the event log replay (515). The process model refiner traverses the process model to locate elements that are unmarked or not identified in a visited list. The process model refiner then removes these elements and the corresponding incoming and outgoing edges or references to other elements. For removals, the process model refiner determines whether path continuity may be lost from removal of an element and/or edge. For instance, a gateway/choice element may be in a path from a first event element to a second event element. Removing the gateway/choice element and the outgoing edge to the second event element terminates the path prematurely. The process model refiner would preserve (or restore) path connectivity to avoid premature termination of the path by adding an edge between the first and the second event elements (e.g., adding a pointer) or reconnecting the outgoing edge to the first event element (e.g., pointer manipulation).

Removal of process model elements may render some elements non-functional. The process model refiner evaluates the intermediate process model after removal of non-visited elements to determine and remove non-functional elements (517). For instance, a transition element (e.g., choice element) my only have a single incoming edge/reference (“path”) and a single outgoing path. With a single incoming path and a single outgoing path, the choice element no longer serves a function in the process model and can be removed.

To avoid complicating the introductory example illustrations, the above example illustrations do not capture nested loops and concurrency, which can occur in process models. Concurrency is a differentiator between process mining and data mining since a process model captures and expresses a process beyond data relationships. When a process model includes nested loops, the forward path executions of nested loops are counted separately from the containing loop.

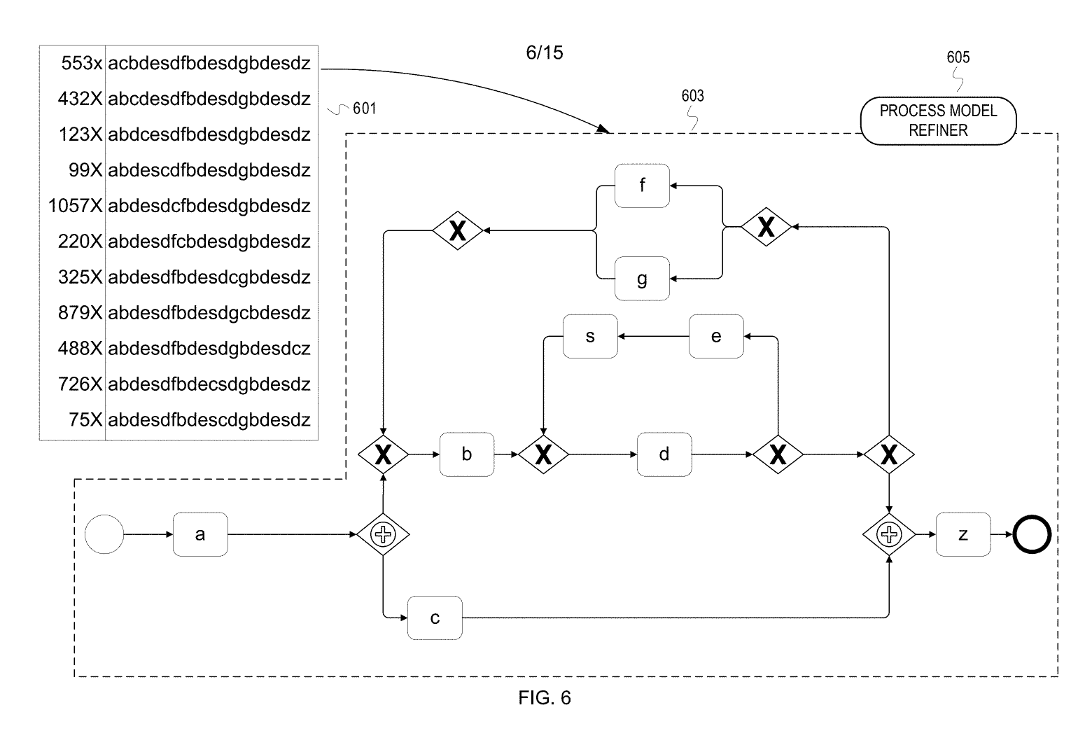

FIGS. 6-11 depict an example refinement from loop unrolling for a process model that has a nested loop and concurrency. FIG. 6 introduces a BPMN type of process model and a corresponding event log. In FIG. 6, a process model refiner 605 receives as input a process model 603. The process model 603 has been mined from an event log 601. As can be seen in FIG. 6, the process model 603 includes concurrent paths beginning with events “b” and “c.” The process model 603 also includes a loop defined by a forward path of the event sequence “bd” and a backwards path of “f” or “g”. The process model 603 also includes a loop with a forward path of “d” and a backwards path of “es,” which is nested within the loop defined by the “bd” path. Since nested loops are considered separately, the process model refiner 605 excludes the nested loop forward path “d” from the forward path of the loop beginning with “b.” Thus, the process model refiner 605 identifies the nested loop by forward path “d” and the containing loop by forward path “b” instead of “bd.” After determining these loops, the process model refiner 605 counts sequential executions of the loops in each trace of the event log 601. In this case, the process model refiner 605 counts 2 sequential executions of the forward path “d” across traces of the event log 601 and counts 3 sequential executions of the forward path “b.” Since the count is 2 for the forward path “d” within each trace of the event log, the gcd is 2. For the loop with forward path “b,” the sequential executions count and gcd are 3.

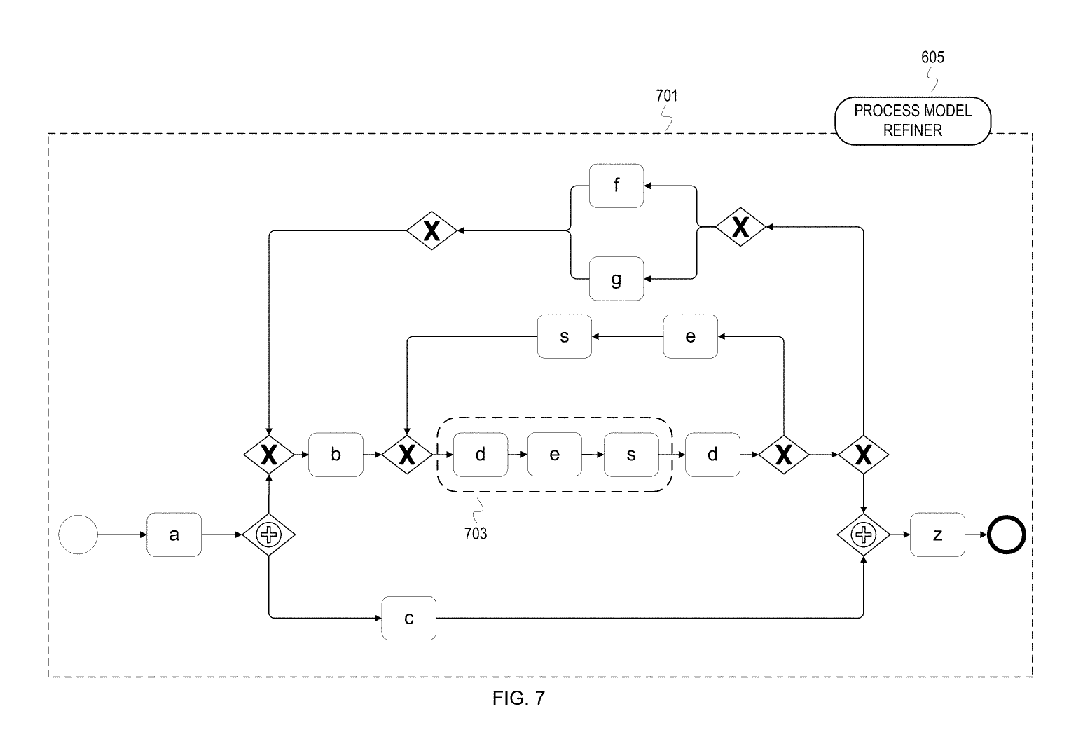

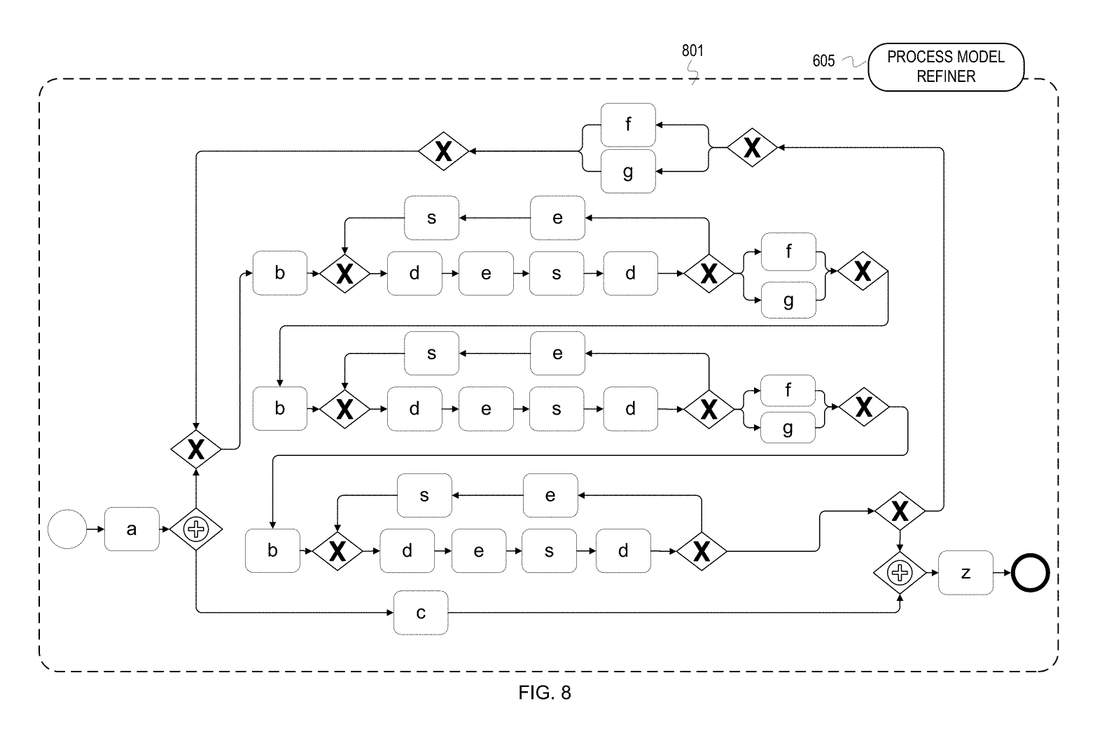

FIG. 7 depicts an intermediate process model with the “d” loop unrolled. The process model refiner 605 unrolls the “d” loop 2 times in accordance with the gcd of the sequential execution counts. To unroll the “d” loop 2 times, the process model refiner 605 inserts the sequence “des” prior to the event “d,” which yields an intermediate process model 701. The dashed line 703 encapsulates the inserted sequence “des” that results in the unrolled loop “desd.” The process model refiner 605 then unrolls the containing loop with forward path “b” based on its gcd=3. FIG. 8 depicts the process model with the “b” loop unrolled. To unroll the “b” loop 3 times, the process model refiner 605 inserts 2 more instances of the “b” loop into the intermediate process model 701 to create the intermediate process model 801. Since the “b” loop includes the nested “d” loop, the additional instances of the “b” loop include the unrolled “d” loop and branch to the sequence “es.” In contrast to the “d” loop, the “b” loop can have different backwards paths. So, the 2 additional instances of the “b” loop also include the gateway elements for splitting and merging between the “f” and “g” elements.

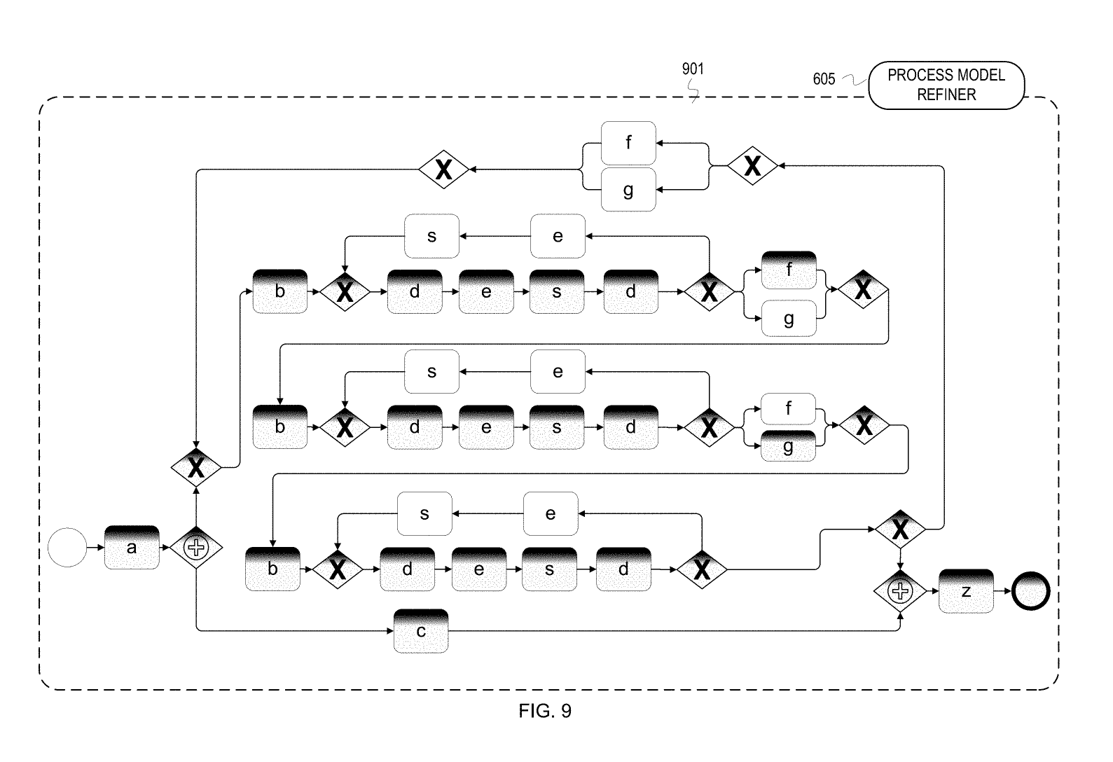

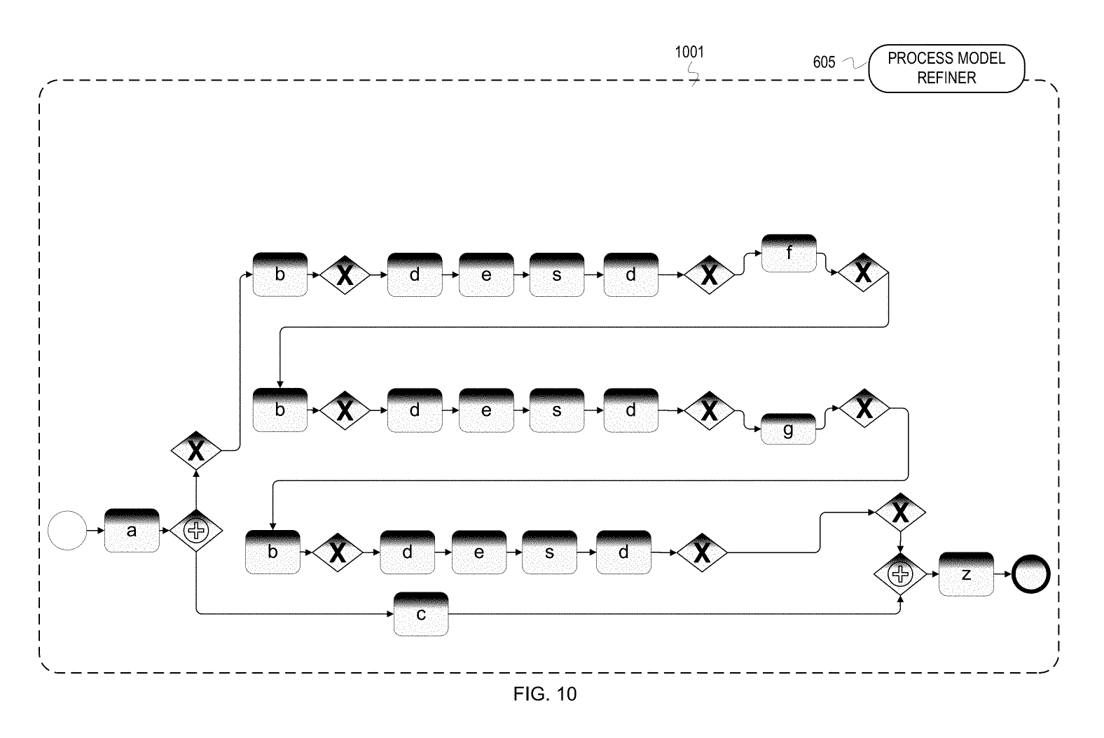

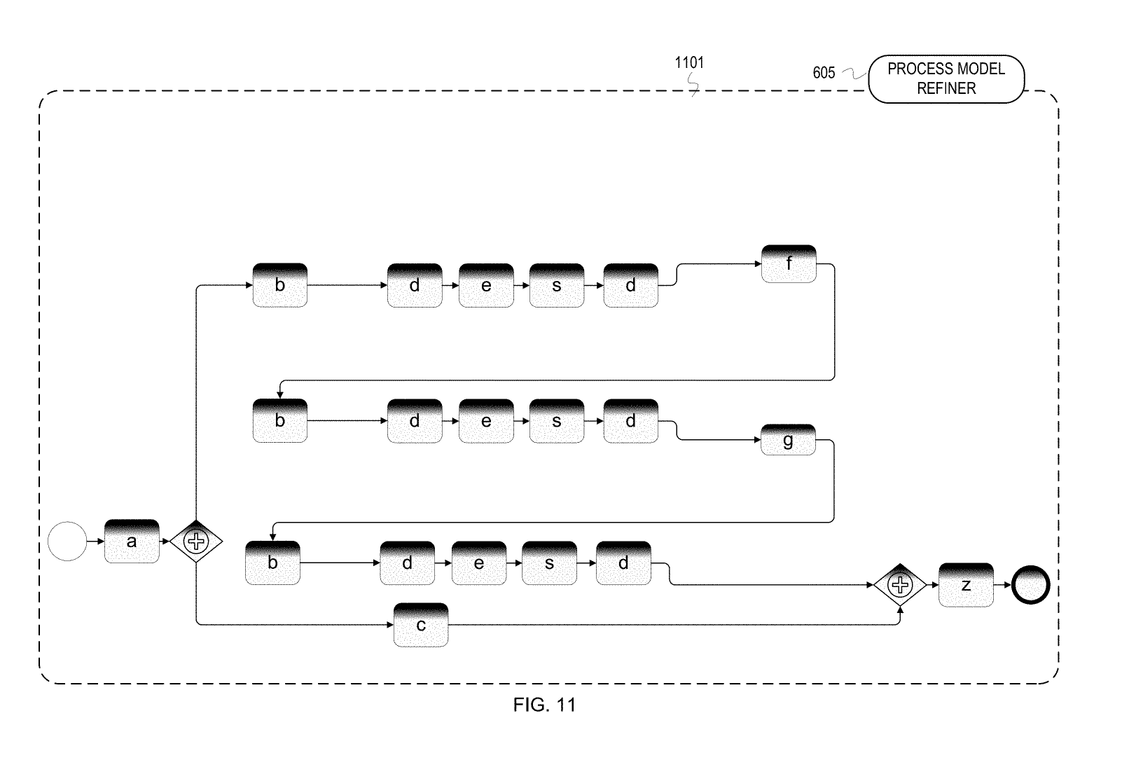

When the process model refiner 605 replays the event log 601 on the intermediate process model 801, the process model refiner 605 marks the elements of the intermediate process model 801 that are traversed. FIG. 9 depicts the intermediate process model 801 with the visited elements marked. The process model refiner 605 then removes the non-visited elements of the intermediate process model 801 to produce an intermediate process model 1001. FIG. 10 depicts the intermediate process model 1001. The process model refiner 605 determines elements rendered non-functional after removal of the non-visited elements and removes the non-functional elements from the intermediate process model 1001 to generate a refined process model 1101 depicted in FIG. 11. In this illustration, the non-functional elements were ten gateway elements that had a single incoming path and a single outgoing path in the intermediate process model 1001.

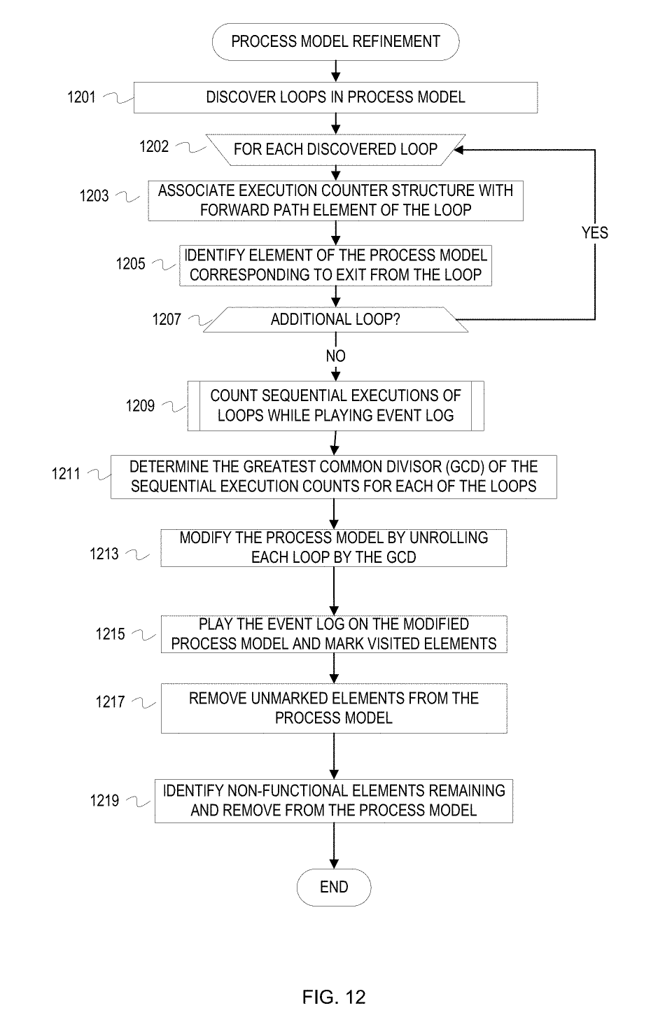

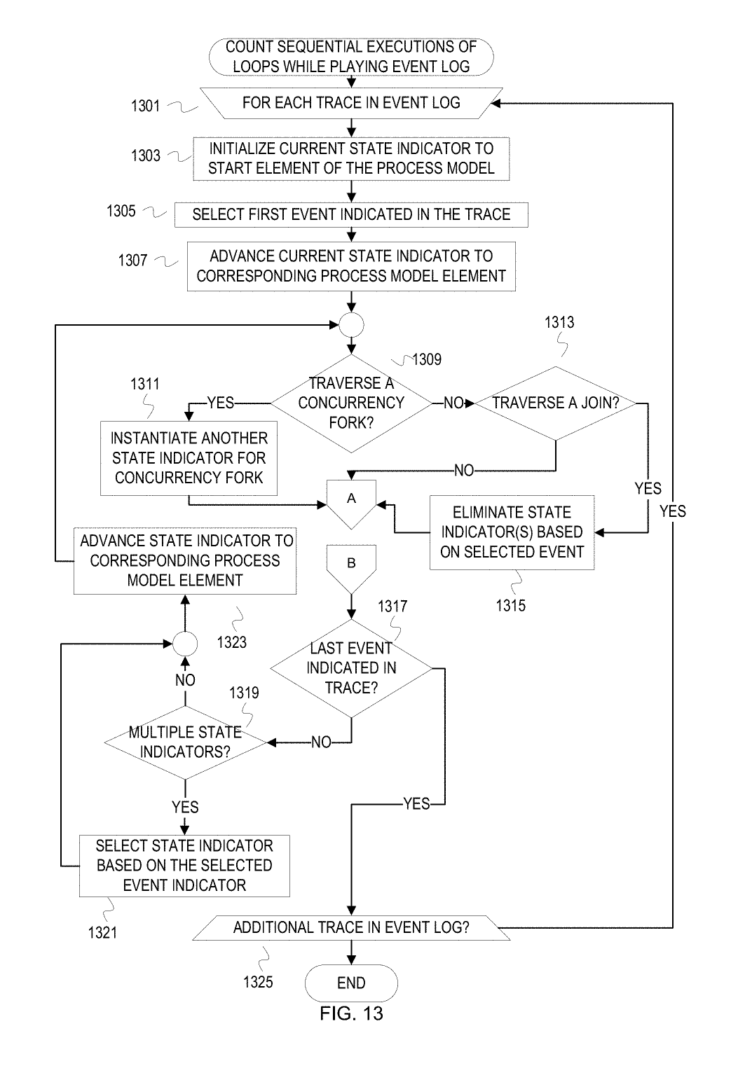

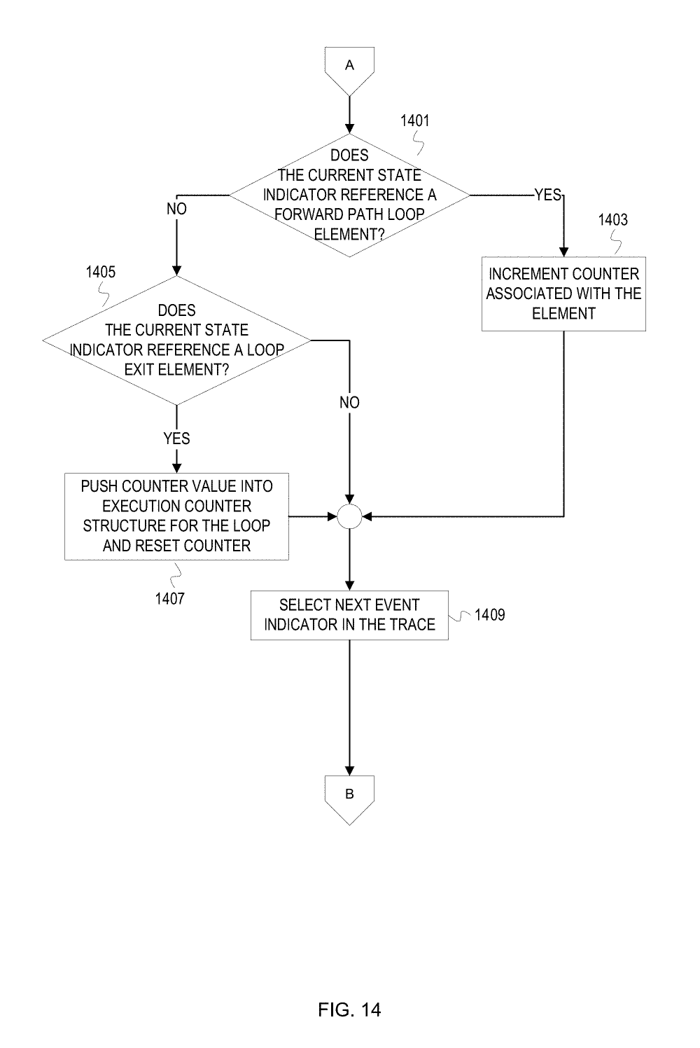

FIGS. 12 -14 depict flowcharts of example operations for loop unrolling based process model refinement that accounts for concurrency and nested loops. As with FIG. 5, FIGS. 12-14 refer to a process model refiner as performing the operations for consistency. FIGS. 12-14 present example operations that include maintaining lists of counts to track sequential executions across concurrent paths and separately track sequential executions of nested loops and outer loops. FIG. 12 depicts a flowchart of example operations that replay an event log for counting loops to guide loop unrolling and for refining the process model after loop unrolling. FIGS. 12-14 presume a type of process model that does not explicitly indicate loops.

A process model refiner discovers loops in a process model that has been mined from an event log (1201). As previously stated, embodiments can use DFS or topological sort to discover loops. Embodiments may use both DFS and topological sort to discover loops, including nested loops. While discovering loops in the process model, the process model refiner may maintain indications of which loops are nested loops, the degree of nesting, the relationships among the loops (e.g., parent loop, sibling loop, etc.). The process model refiner can use these indications later to guide unrolling of loops from innermost to outermost loop. As part of discovery, the process model refiner determines an element of the process model corresponding to a forward path of each loop. The process model refiner can identify each loop by the element. For instance, the forward path element may indicate an event “c.” The process model refiner can identify the loop with the event indicator “c.” If the same forward path element corresponds to loops on concurrent paths, then the process model refiner can use additional information to distinguish between the loops on concurrent paths (e.g., backwards path identifier, a concurrent path annotation, etc.). The process model refiner can annotate the process model by setting flags/variables to identify forward path loop elements or maintain a separate structure of forward path loop element identities.

For each loop that the process model refiner discovers (1202), the process model refiner establishes a counter and discover more topological information about the process model. The process model refiner associates a data structure for counting sequential executions (“execution counter structure”) with the forward path element of the loop (1203). The execution counter structure can include a count variable and a function/method is increments the variable at each sequential execution of a loop. The execution counter structure can also include a linked list for storing sequential execution counts for a loop. An embodiment may maintain a gcd that is evaluated after each sequential execution count instead of or in addition to a list of sequential execution counts. For each discovered loop, the process model refiner identifies an element of the process model that corresponds to an exit of the loop (1205). As with forward path loop elements, the process model refiner can annotate the process model or maintain a separate data structure to identify loop exit elements. The process model refiner can use identity of the exit element for a loop to determine when to stop incrementing the sequential execution counter for a loop. The process model refiner continues with establishing the execution counter structures for the loops and exit element identification (1207).

After establishing the execution counter structures and identifying loop exit elements, the process model refiner replays the event log on the process model and counts sequential executions of the loops while replaying the event log (1209). The process model refiner replays each trace of the event log and updates the execution counter structures based on replaying the event log.

FIGS. 13-14 depict a flowchart of example operations for counting sequential executions of loops of a process model while replaying an event log on the process model. FIGS. 13-14 continue referring to the process model refiner for consistency with FIG. 12.

The process model refiner maintains a current state pointer to traverse the process model in accordance with each trace of the event log (1301). The process model refiner initializes a current state indicator to a start element of the process model (1303). The current state indicator can be a pointer that references a current element of the process model, an identifier of the current element of the process model, etc. The process model refiner then selects the first event indicated in the trace (1305). The process model refiner can also maintain a pointer to the current event indication of the trace or traverse the structure used for each trace (e.g., array or linked list). Based on the current event indication, the process model refiner advances the current state indicator to an element of the process model that corresponds to the selected event indication (1307). To advance the current state indicator, the process model refiner traverses the process model from the currently referenced process model element to an element that indicates the selected event. This can involve traversing an edge between elements that indicate events or traversing a gateway/transition element (e.g., choice element, split/fork element, etc.).

If a gateway element is to be traversed, then the process model refiner can look ahead to which path to take to match the trace traversal. If a concurrency fork element is traversed (1309), then the process model refiner instantiates another current state indicator for the other path after the concurrency fork (1311). The process model refiner set the newly instantiated current status indicator to indicate the concurrency fork element. If a join element is traversed (1313), then the process model refiner can eliminate one or more current state indicators depending on the number of concurrent paths merging at the join element (1315). The process model refiner can also leave the current status indicator of joined paths set to indicate the join element. The process model refiner does not eliminate the current status indicator that has been advanced to the event element corresponding to the selected event indication of the trace.

If the process model refiner does not traverse an element related to concurrency forking or joining or after updating structures based on encountering a fork element or join element, the process model refiner determines whether the current state indicator has advanced to an event element that is a forward path element of a loop (1401). The process model refiner can examine the referenced event element if the process model has been annotated. The process model refiner may search a separate structure of forward path loop elements to determine whether the separate structure includes an indication of the event element referenced by the current status indicator. If the referenced event element is a forward path loop element, then the process model refiner increments a counter associated with the forward path loop element (1403). If the referenced event element is a loop exit element (1405), then the process model refiner pushes a counter value for the loop being exited into an execution counter structure associated with the loop being exited 1407. If a loop is being exited, then the process model refiner has already incremented a counter at least once for the loop when first entered. The process model refiner can maintain a last-in-first-out (LIFO) type of list for active sequential execution counters since inner loops will exit prior to containing outer loops. Since nested loops may be executed concurrently, the process model refiner can instantiate and maintain a LIFO list for active sequential execution counters per concurrent path. Embodiments can also identify counters by forward path element identifier and concurrency path identifier. When the process model refiner determines that a loop is being exited, the process model refiner determines the forward path loop element of the loop being exited and then determines an active sequential execution counter with a forward path loop element identifier and path identifier.

After updating the execution counter structure or determining that the currently referenced event element does not correspond to a loop, the process model refiner selected the next event indicator in the trace (1409). If the selected event indicator is the last in the trace (1317), then the process model refiner proceeds to traversing the next trace of the event log, if any (1325). If the selected event indicator is not the last of the trace (1317), then the process model refiner determines whether there are multiple current state indicators (1319). If there are multiple current state indicators, then the process model refiner selects one based on the currently selected event indicator of the trace (1321). The process model refiner can look ahead for each of the current status indicators until finding one that would advance to an event element that matches the currently selected event indicator of the trace.

After selecting a current status indicator or if only one status indicator exists, the process model refiner advances the (selected) current status indicator to the event element of the process model that corresponds to the currently selected event indicator of the trace (1323). The process model refiner then repeats evaluating each process model element referenced by the current status indicator(s) as it advances through the process model for each trace until the event log has been replayed.

After counting the sequential executions of each of the loops, the process model refiner determines an extent of unrolling for each of the loops and unrolls each of the loops accordingly. The process model refiner determines the gcd of the sequential execution counts for each of the loops (1211). The process model refiner can evaluate each list or set of sequential execution counts to determine the gcd of the counts for a loop. The process model refiner then unrolls each of the loops based on the respective gcd (1213). The unrolling process generates one or more intermediate process models. As stated earlier, the process model refiner can use information about each of the loops to unroll loops from the innermost nested loops to the outermost loops.

After unrolling the loops of the process model, the process model refiner re-plays the event log on the intermediate process model with the unrolled loops (1215). As in FIG. 5, the process model refiner tracks the elements of the intermediate process model that are not visited during the replaying of the event log on the intermediate process model and then removes those elements that are not visited (1217). The process model refiner also removes elements rendered non-functional after removal of the non-visited elements (1219). The resulting process model is a more precise model and can be more useful to organizations that use the more precise model in process mining for auditing, compliance enforcement, process deviation detection, etc.

Variations

The example illustrations remove elements of an intermediate process model that are not visited during replaying of the corresponding event log. Embodiments can also utilize execution thresholds to remove elements. For instance, a process model refiner can maintain an execution frequency counter for each element and remove elements of a process model that do not satisfy an execution frequency threshold after replaying of the event log. The threshold can be tuned based on the resulting process model. This elimination of infrequently executed elements from the process model trades fitness for simplicity.

The example illustrations also refer to unrolling a loop a number of times based on the gcd of the sequential execution counts across traces. However, a sequential execution count that is infrequent can prevent effective unrolling of a loop. For example, a loop may have sequential execution counts of 7, 6, 6, 3, and 3 across traces in an event log. The single 7 count will prevent unrolling of the loop 3 times since the other counts have a gcd of 3. However, embodiments can disregard a count with infrequent behavior, where “infrequent” can be a defined count frequency threshold. Embodiments may condition this disregarding of an infrequent count behavior on the infrequent count behavior being greater than the gcd of the counts being considered.

The example illustrations also describe the process model as being discovered or mined from the event log and being able to replay the event long on the process model. Embodiments, however, are not limited to process models discovered from process mining of an event log and perfect alignment with an event log is not necessary. A model designed instead of discovered from process mining can be modified as described herein to adjust precision to an event log. Furthermore, a process model can be refined that does not perfectly fit traces of an event log. The process model may be able to replay some but not all traces of an event log or be able to replay traces similar to those in the event log. The process model can be unrolled and refined based on the subset of traces and/or similar traces.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the example operation depicted with block 507 could be performed outside of the loop. A process model refiner could determine the counts and gcd's for the determined loops prior to unrolling. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

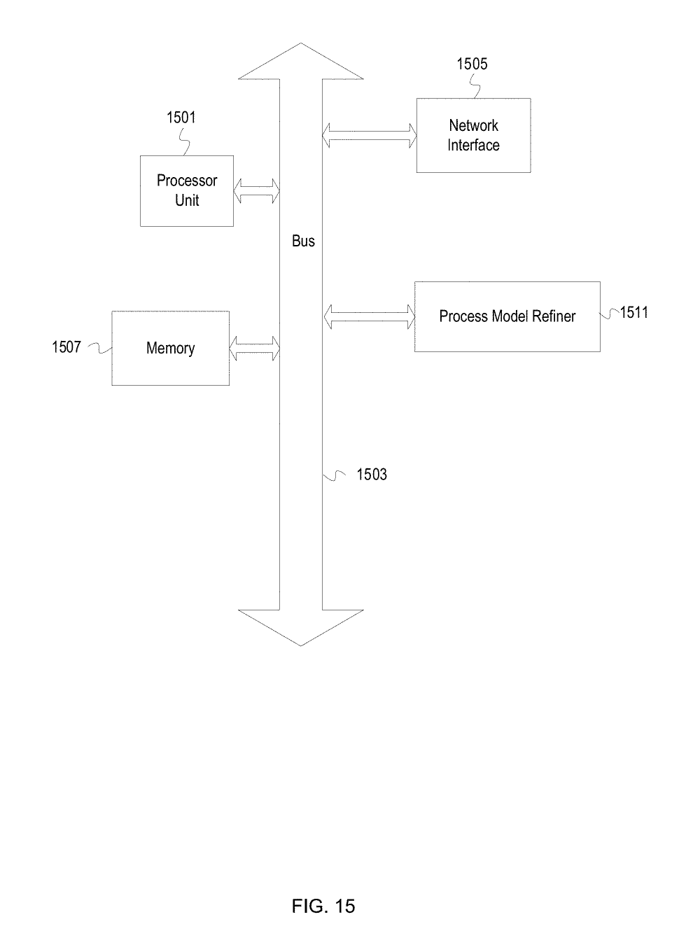

FIG. 15 depicts an example computer system with a process model refiner. The computer system includes a processor 1501 (possibly also including multiple processors, multiple cores, multiple nodes, and/or implementing multi-threading, etc.). The computer system includes memory 1507. The memory 1507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 1503 (e.g., PCI, ISA, PCI-Express, HyperTransport® bus, InfiniBand® bus, NuBus, etc.) and a network interface 1505 (e.g., a Fiber Channel interface, an Ethernet interface, an internet small computer system interface, SONET interface, wireless interface, etc.). The system also includes a process model refiner 1511. The process model refiner 1511 discovers loops in a process model mined from an event log. For each of the loops, the process model refiner counts sequential executions of the loops across traces of the event log, and then unrolls the loops based on a gcd of the counts. Any one of the previously described functionalities may be partially (or entirely) implemented in hardware and/or on the processor 1501. For example, the functionality may be implemented with an application specific integrated circuit, in logic implemented in the processor 1501, in a co-processor on a peripheral device or card, etc. Further, realizations may include fewer or additional components not illustrated in FIG. 15 (e.g., video cards, audio cards, additional network interfaces, peripheral devices, etc.). The processor 1501 and the network interface 1505 are coupled to the bus 1503. Although illustrated as being coupled to the bus 1503, the memory 1507 may be coupled to the processor 1501.

While the aspects of the disclosure are described with reference to various implementations and exploitations, it will be understood that these aspects are illustrative and that the scope of the claims is not limited to them. In general, techniques for modifying a process model to increase precision of the process model as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
identifying a set of one or more loops in a first process model;
for each identified loop,
determining counts of sequential executions of the loop in traces of an event log that corresponds to the first process model;
determining a greatest common divisor based, at least in part, on the counts of sequential executions;
unrolling the determined loop based, at least in part, on the greatest common divisor;
identifying elements of an intermediate process model that are not visited based, at least in part, on replaying the event log on the intermediate process model, wherein the intermediate process model is produced from unrolling the loops in the first process model; and
removing from the intermediate process model the identified elements.

2. The method of claim 1, wherein the first process model is mined from the event log.

3. The method of claim 1 further comprising marking visited elements of the intermediate process model while replaying the event log on the intermediate process model, wherein identifying the elements of the intermediate process model that are not visited comprises identifying unmarked elements of the intermediate process model.

4. The method of claim 1 further comprising determining elements rendered non-functional after removing the identified elements and removing the non-functional elements from the intermediate process model.

5. The method of claim 4, wherein determining elements rendered non-functional comprises determining choice elements with a single incoming path and a single outgoing path after removing elements identified as not visited when the event log was replayed on the intermediate process model.

6. The method of claim 1, wherein determining counts of sequential executions of the identified loops comprises determining counts of sequential executions of forward paths of the determined loops based, at least in part, on replaying the event log on the first process model.

7. The method of claim 1 further comprising generating a second process model based, at least in part, on removing the identified elements from the intermediate process model.

8. The method of claim 1, wherein the elements comprises data structures that represent nodes of the intermediate process model.

9. The method of claim 1 further comprising:
maintaining an execution frequency count for each of the elements of the intermediate process model while replaying the event log on the intermediate process model; and
removing from the intermediate model elements with an execution frequency count that does not satisfy an execution frequency threshold.

10. The method of claim 1, wherein determining the greatest common divisor based, at least in part, on the counts of sequential executions of a determined loop comprises determining the greatest common divisor based on counts of sequential executions that satisfy a threshold.

11. The method of claim 1, wherein determining counts of sequential executions of each determined loop comprises determining counts of sequential executions of nested loops independent of sequential executions of a containing loop.

12. One or more non-transitory machine-readable media comprising program code for increasing precision of a mined process model, the program code to:
determine a set of one or more loops in the mined process model, wherein each of the set of loops comprises a forward path in the mined process model;
determine counts of sequential executions of each forward path in an event log that corresponds to the mined process model
determine a greatest common divisor for each of the set of one or more loops based, at least in part, on the counts of sequential executions;
unroll each determined loop based, at least in part, on the greatest common divisor which produces an intermediate process model;
identify elements of the intermediate process model that are not visited based, at least in part, on replaying the event log on the intermediate process model; and
remove from the intermediate process model the identified elements.

13. The machine-readable media of claim 13, further comprising program code to:
maintain an execution frequency count for each of the elements of the intermediate process model while replaying the event log on the intermediate process model; and
remove from the intermediate model elements with an execution frequency count that does not satisfy an execution frequency threshold.

14. The machine-readable media of claim 13, wherein the program code to determine the greatest common divisor based, at least in part, on the counts of sequential executions of a determined loop comprises program code to disregard counts of sequential executions that are infrequent in the event log.

15. The machine-readable media of claim 13, wherein the program code to determine counts of sequential executions of each determined loop comprises program code to determine counts of sequential executions of nested loops before determining counts of sequential executions of loops that contain a nested loop.

16. An apparatus comprising:
a processor; and
a machine-readable medium comprising program code executable by the processor to cause the apparatus to,
identify a set of one or more loops in a first process model;
for each of the set of one or more loops,
determine counts of sequential executions of the loop in traces of an event log that corresponds to the first process model;
determine a greatest common divisor based, at least in part, on the counts of sequential executions;
unroll the determined loop based, at least in part, on the greatest common divisor;
identify elements of an intermediate process model that are not visited based, at least in part, on replaying the event log on the intermediate process model, wherein the intermediate process model results from unrolling of loops; and
remove from the intermediate process model the identified elements.

17. The apparatus of claim 17, wherein the program code further comprises program code executable by the processor to cause the apparatus to discover the set of one or more loops before identifying the set of one or more loops.

18. The apparatus of claim 17, wherein the machine-readable medium further comprises program code executable by the processor to cause the apparatus to mark visited elements of the intermediate process model while replaying the event log on the intermediate process model, wherein the program code to identify the elements of the intermediate process model that are not visited comprises program code to identify unmarked elements of the intermediate process model.

19. The apparatus of claim 17, wherein the machine-readable medium further comprises program code executable by the processor to cause the apparatus to determine elements rendered non-functional after removal of the identified elements and to remove the non-functional elements from the intermediate process model.

20. The apparatus of claim 17, wherein the machine-readable medium further comprises program code executable by the processor to cause the apparatus to:
maintain an execution frequency count for each of the elements of the intermediate process model while replaying the event log on the intermediate process model; and
remove from the intermediate model elements with an execution frequency count that does not satisfy an execution frequency threshold.
